(19) United States
(12) Patent Application Publication
(10) Pub. No.: US 2025/0160234 A1
(43) Pub. Date: May 22, 2025

(54) AGRICULTURAL MACHINE WITH ACTIVE COUPLING POINTS

(71) Applicant: KUHN SAS, Saverne (FR)

(72) Inventor: Cédric SPEICH, Alteckendorf (FR)

(73) Assignee: KUHN SAS, Saverne (FR)

(21) Appl. No.: 18/953,849

(22) Filed: Nov. 20, 2024

(30) Foreign Application Priority Data
Nov. 21, 2023 (FR) 2312785

(51) Int. Cl. A01B 59/043; A01D 78/10

(52) U.S. Cl. CPC A01B 59/043; A01D 78/1007

(57) ABSTRACT

An agricultural machine includes: a work tool, a coupling frame including a crossing beam and two levers, each lever carrying a respective hitching point attached to a respective lower arm of the tractor and being able to move vertically relative to the crossing beam, each lever having an associated restoring device which can exert a force on the associated lever when the respective hitching point moves vertically relative to the crossing beam. The machine is able to occupy a work configuration in which the tool is close to the surface and a transport configuration, in which the tool is further away from the surface. Each restoring device includes a hydraulic restoring jack fixed to the respective lever on one side and to the crossing beam on another side, each restoring jack being hydraulically connected to a hydraulic tank in the work configuration.

### BACKGROUND OF THE INVENTION

### Field of the invention

The present invention relates to the field of agricultural machinery and more particularly to an agricultural machine comprising at least one work tool and a coupling frame, by which it is connected to a tractor and which comprises a crossing beam and two levers, each lever carrying a respective hitching point intended to be attached to a respective lower arm of the tractor and being movable vertically relative to the crossing beam, each lever being associated with a restoring device capable of exerting a force on the associated lever, when the respective hitching point moves vertically relative to the crossing beam, the machine being able to occupy a work configuration in which the or each tool is close to the surface, and at least one transport configuration in which the or each tool is further away from the surface than in the work configuration.

### Description of the Related Art

Such a machine is described in document EP 2 953 445 A1. In this document, the restoring device comprises elastically deformable elements making it possible to store and release energy to the associated hitching point as it moves vertically. Such restoring devices make it possible to reduce the risk of the machine tipping over in the transport configuration by storing a force which they return to the lever(s) to bring it (them) back to the initial position. In the machine's work configuration, the elastically deformable elements of these restoring devices also transmit forces between the tractor and the machine, when a hitching point is moved vertically in relation to the machine's coupling frame, which can imply a reduced service life for the tractor's coupling device and the machine's coupling frame. In addition, the elastically deformable elements also mean a limited amplitude of hitching point deflection, leading to limited adaptation of the machine to a bumpy surface, which can lead to poorer work quality, as well as tool and/or surface damage.

### SUMMARY OF THE INVENTION

The aim of the present invention is to overcome at least some of the aforementioned drawbacks for such an agricultural machine.

To this end, each restoring device comprises a hydraulic restoring jack attached to the respective lever on one side and to the crossing beam on another, each restoring jack being hydraulically connected to a hydraulic tank in the work configuration.

As a result of this arrangement, the machine moves more freely in relation to the tractor in the work configuration, allowing the machine to better adapt to a bumpy surface, and advantageously reducing stresses in the tractor's coupling device and in the machine's coupling frame.

### BRIEF DESCRIPTION OF THE DRAWINGS

The invention will be better understood through the following description, which refers to different preferred embodiments given as non-limiting examples and explained with reference to the attached schematic drawings, in which:

FIG. 1 shows a simplified top view of a machine according to a first variant of the invention, coupled to the rear of a tractor, in which the coupling cylinders are concealed,

FIG. 2 shows a perspective view of a coupling according to the preferred embodiment of the invention,

FIG. 3 shows a side view of a machine according to a preferred variant of the invention, in the work configuration,

FIG. 4 shows a simplified side view of the machine according to the preferred variant of the invention, in the transport or maneuvering configuration,

FIG. 5 shows a schematic diagram of the machine's hydraulic circuit according to the preferred variant, with the machine's hydraulic circuit connected to the tractor's hydraulic circuit, and

FIG. 6 shows a side cross-section view of the coupling shown in FIG. 2, the location of the cross-section being shown in FIG. 1.

### DETAILED DESCRIPTION OF THE PREFERRED EMBODIMENTS

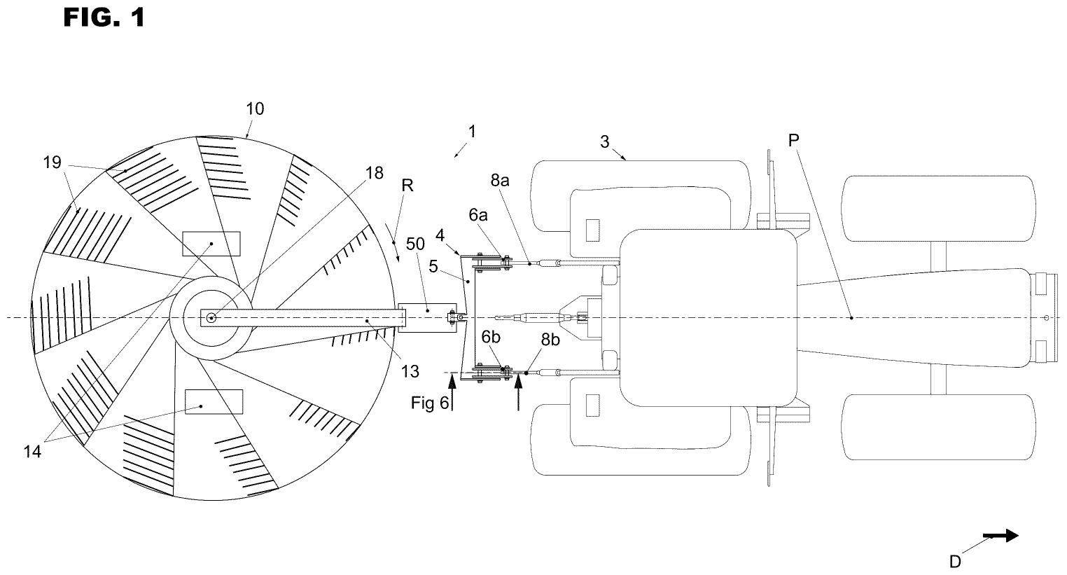

As shown in FIG. 1, the agricultural machine 1 according to the invention comprises at least one tool 10. The machine 1 also comprises a coupling frame 4 by which it is connected to a tractor 3. The tractor 3 comprises two lower arms 8a, 8b. The tractor 3 is equipped with a coupling device comprising a left lower arm 8a and a right lower arm 8b. The tractor 3 is able to move with or without the machine 1 in a main direction D. The tractor 3 moves over a surface S. It is the surface S of the ground over which the tractor 3 and machine 1 move, preferably the surface S of a field when the machine 1 is working. The tractor 3 also makes it possible to drive the machine 1, notably via its power take-off and/or its hydraulic circuit. A central plane P passes through the middle of the tractor 3. The central plane P is vertical. It is also parallel to the main direction D. The central plane P is equidistant from the lower arms 8a, 8b.

In the present description, the concepts front, back, in front, behind, right and left are defined looking in the main direction D.

The machine 1 also comprises at least one beam 13. The beam 13 connects the at least one tool 10 to the coupling frame 4. Preferably, the beam 13 connects the at least one tool 10 to the coupling frame 4 via at least one drawbar 50. The coupling frame 4 is preferably located in front of the beam 13. The machine 1 is thus preferably coupled to the rear coupling device of the tractor 3. In an embodiment not shown, the machine 1 could however be coupled to the front coupling device of the tractor 3.

The machine 1 has a hydraulic circuit 40. The tractor 3 also has a hydraulic circuit 30. The hydraulic circuit 30 of the tractor 3 includes at least one tank 33. The tank 33 is atmospheric. In other words, the tank 33 is designed to store a liquid at close to atmospheric pressure. The hydraulic circuit 30 of the tractor 3 also comprises a pump 31 and a hydraulic directional control valve 32. The hydraulic circuit 30 of the tractor 3, and in particular the pump 31 or tank 33, can be connected to the hydraulic circuit 40 of the machine 1 via the control valve 32. The pump 31 makes it possible to deliver pressurized oil to the hydraulic circuits 30, 40. The pump 31, tank 33 and/or the control valve 32 may also form part of the hydraulic circuit 40 of the machine 1.

The coupling frame 4 comprises a crossing beam 5 and two levers 6a, 6b. Each lever 6a, 6b carries a respective hitching point 7a, 7b. Each hitching point 7a, 7b is designed to be attached to a respective lower arm 8a, 8b of the tractor 3. In this document, many parts are symmetrical with respect to the central plane P. It is agreed to reference these symmetrical parts on the left of the central plane P with an a and those on the right with a b. It is therefore agreed to reference a first lever, the left lever 6a, and a second lever, the right lever 6b. In the same way, it is also agreed to name a first hitching point, the left hitching point 7a, and a second hitching point, the right hitching point 7b, etc. Therefore, the first hitching point 7a is attached to the left lower arm 8a of the coupling device of the tractor 3 and the second hitching point 7b is attached to the right lower arm 8b of the coupling device of the tractor 3. The vertical is orthogonal to the main direction D and to the line passing through the hitching points 7a, 7b. The line passing through the hitching points 7a, 7b is preferably horizontal.

To allow a good adaptation of the machine 1 to the tractor 3 when they are moving over a bumpy surface S, each hitching point 7a, 7b can move vertically relative to the crossing beam 5. In addition, each hitching point 7a, 7b is articulated with the associated lever 6a, 6b around a coupling axis 16a, 16b. Each coupling axis 16a, 16b is horizontal. Each coupling axis 16a, 16b is also perpendicular to the main direction D.

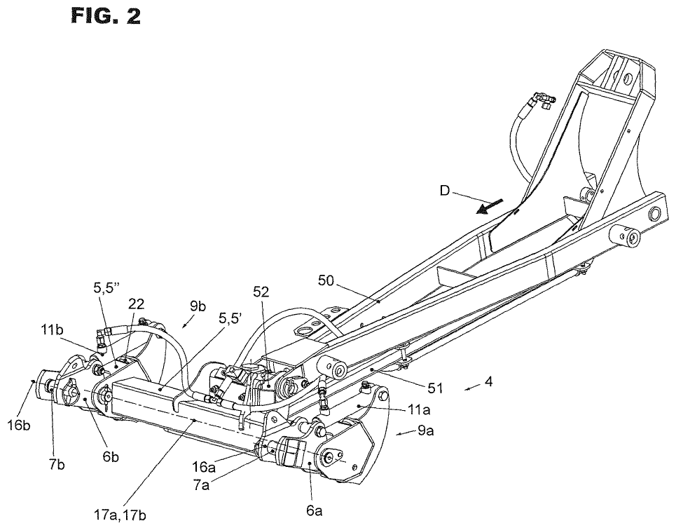

As shown in particular in FIG. 2, each lever 6a, 6b has an associated restoring device 9a, 9b. Each restoring device 9a, 9b can exert a force on the associated lever 6a, 6b when the respective hitching point 7a, 7b moves vertically relative to the crossing beam 5.

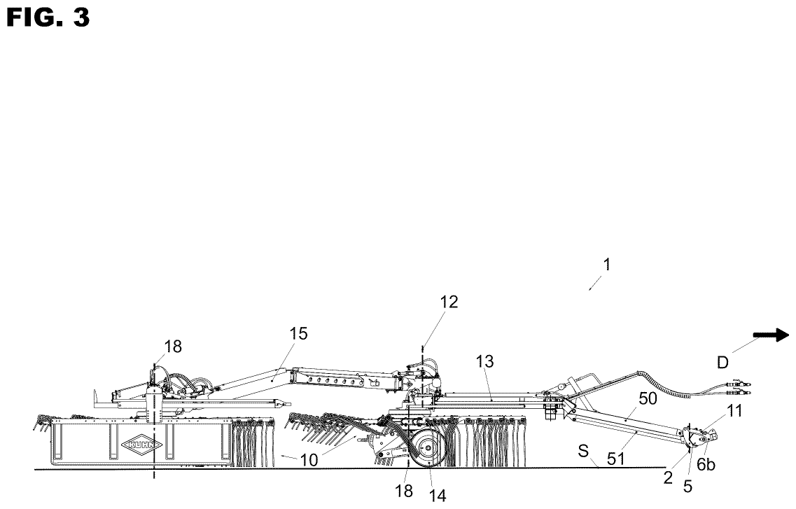

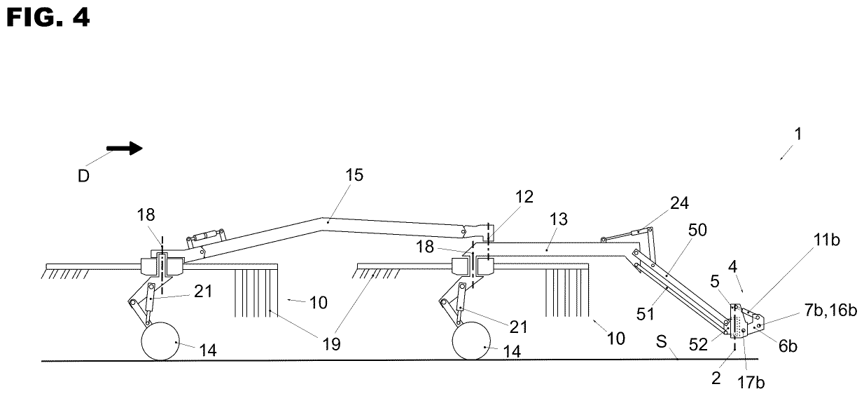

In the first embodiment variant shown in FIG. 1, the tool 10 is attached to the rear end of the beam 13. In the preferred variant shown in FIG. 3, a rear tool 10 is attached to a rear beam 15. The front tool 10 is located in front of the rear tool 10. The rear beam 15 is connected to the beam 13 by an articulation allowing at least one pivoting about a substantially vertical central axis 12. As shown in FIG. 3, the machine 1 can occupy a work configuration in which the or each tool 10 is close to the surface S. As shown in FIG. 4, the machine 1 can also occupy a transport configuration, in which the or each tool 10 is further away from the surface S than in the work configuration.

The machine 1 can preferably also occupy a maneuvering configuration in which the or each tool 10 is also distant from the surface S. In the first variant of FIG. 1, the maneuvering and transport configurations are substantially identical. In the work configuration, the beam 13 is also closer to the surface S than in the transport and maneuvering configuration. The machine 1 rests on the surface S via small wheels 14, whatever the configuration (work, transport or maneuvering) of the machine 1. Preferably at least two respective small wheels 14 are associated with each tool 10. Preferably, the small wheels 14 are oriented so that the beam 13 is substantially parallel to the main direction D.

According to one important feature of the invention, each restoring device 9a, 9b comprises a hydraulic restoring jack 11a, 11b. Each restoring jack 11a, 11b is fixed to the respective lever 6a, 6b on one side and to the crossing beam 5 on another side. Respectively, each restoring jack 11a, 11b is rigidly fastened to the respective lever 6a, 6b by its stem or cylinder. Each restoring jack 11a, 11b is also rigidly fastened to the crossing beam 5 by means of the one of its stem or cylinder which is not rigidly fastened to the respective lever 6a, 6b. In the work configuration, each restoring jack 11a, 11b is hydraulically connected to a hydraulic tank 33. In other words, in the work configuration, the pressure in the chambers of each restoring jack 11a, 11b is substantially equal to the atmospheric pressure. The restoring jacks 11a, 11b are said to be mounted in floating manner. In this way, each restoring jack 11a, 11b extends and/or retracts freely in the work configuration. As a result, the machine 1 moves more freely in its work configuration, improving its ability to adapt to a bumpy surface S and reducing stress on the coupling frame 4 and the coupling device of the tractor 3 when moving the machine 1 over a bumpy surface S.

As shown in FIG. 4, the drawbar 50 and a rod 51 are each articulated with the beam 13 along a respective horizontal axis. An adapter 52 is articulated with at least the drawbar 50 about a horizontal axis. Preferably, the adapter 52 is also articulated with the rod 51 about a horizontal axis. The adapter 52 is also articulated with the crossing beam 5 along a vertical tracking axis 2, allowing the drawbar 50 and the beam 13 to form an angle, seen from above, with the main direction D when turning, preventing or reducing sliding of the machine 1 over the surface S.

It can be seen from the above that the drawbar 50, the rod 51, the beam 13 and the adapter 52 form a four-bar mechanism. This four-bar mechanism is preferably a deformable parallelogram, which enables the coupling frame 4 to keep the same position in both the work and transport configurations, even when the machine 1 cannot pivot relative to the tractor 3 about a horizontal axis such as the coupling axis 16a, 16b.

The crossing beam 5 connects the levers 6a, 6b to the drawbar 50. The crossing beam 5 thus extends transversely to the main direction D. Preferably, the crossing beam 5 extends perpendicular to the main direction D. The crossing beam 5 connects the levers 6a, 6b to the drawbar 50, preferably via the adapter 52, enabling the machine 1 to better follow the trajectory of the tractor 3. When the tractor 3 and the machine 1 are moving in a straight line, the drawbar 50 preferably extends parallel to the main direction D.

The beam 13 connects the at least one tool 10 with the drawbar 50. The beam 13 is preferably articulated with the drawbar 50 along a substantially horizontal axis, allowing the at least one tool 10 to be moved away from the surface S of the ground in the transport configuration. Always to this end, the drawbar 50 is also articulated with the crossing beam 5 along a substantially horizontal axis. Preferably, the drawbar 50 is directly articulated with the adapter 52 along a substantially horizontal axis. Preferably, the at least one tool 10 is guided in rotation with the beam 13 around the respective drive axis 18. When the tractor 3 and the machine 1 move in a straight line, the beam 13 preferably extends parallel to the main direction D.

As shown in FIG. 4, a lifting jack 21 is associated to each tool 10. The or each lifting jack 21 makes it possible to raise and lower the tool 10 with which it is associated. More precisely, the or each lifting jack 21 makes it possible to move the or each tool 10 away from its respective small wheels 14. Each lifting jack 21 is hydraulic. Since the weight of the machine 1 can allow it to be lowered between its maneuvering and work configurations, the or each lifting jack 21 is preferably single-acting. Supplying pressurized oil to the or to each lifting jack 21 then allows only the associated tool 10 to be raised. To move from the work configuration to the transport configuration, the lifting jack 21 of each tool 10 is extended. In the preferred embodiment, the or each lifting jack 21 is connected to the same control valve 32 as the restoring jacks 11a, 11b.

When the tractor 3 and the machine 1 move over a flat surface, each restoring jack 11a, 11b has a defined length at rest. Preferably, the resting length of the two restoring jacks 11a, 11b is identical, so that when the tractor 3 and the machine 1 move on a flat surface, the coupling axes 16a, 16b are coincident. When the tractor 3 and/or the machine 1 travel(s) over a bumpy surface, the length of at least one restoring jack 11a, 11b is modified since the restoring jacks 11a, 11b are mounted in a floating manner (connected to the hydraulic tank 33) in the work configuration.

In the preferred embodiment, when the tractor 3 and the machine 1 are on a flat surface S, the restoring jacks 11a, 11b are preferentially retracted, regardless of the configuration (work, transport or maneuvering) of the machine 1. Indeed, the weight of the front tool 10, the beam 13 and/or the coupling frame 4 causes the restoring jacks 11a, 11b to retract on a flat surface. The resting length of a restoring jack 11a, 11b is thus its minimum length.

When in the work configuration a rear wheel of the tractor 3 is in a hole, the restoring jack 11a, 11b located on the side of said rear wheel can extend. If, conversely, a rear wheel of the tractor 3 is on a bump, the restoring jack 11a, 11b located on the opposite side of said rear wheel extends. As can be seen from the above, allowing free extension of the two restoring jacks 11a, 11b in the work configuration makes it possible to adapt to any type of unevenness of the surface S, at least over a given deflection range. According to one interesting feature, each restoring jack 11a, 11b is thus a single-acting jack, reducing the number of pipes required and potentially of hydraulic control valves to operate the machine 1, while allowing good adaptation of the machine 1 on a bumpy surface S. In an alternative embodiment not shown, when the tractor 3 and the machine 1 are on a flat surface S, the pistons of the restoring jacks 11a, 11b could also be at mid-stroke, or the restoring jacks extended.

As shown in FIGS. 1, 3 and 4, the machine 1 is preferably trailed. The machine 1 is preferably a trailed windrower. In these figures, the or each tool 10 is a rotor with raking fingers 19. In the work configuration, the or each tool 10 can be driven in rotation in one direction of rotation R, so that the fingers 19 move product lying on the surface S. The product is preferably plant-based, such as cut grass or straw. In the variants shown, each tool 10 is driven in rotation around a respective drive axis 18 that is substantially vertical, at least in the work configuration. A cam track makes it possible to guide the orientation of the fingers 19 based on their position around the drive axis 18, so that when the tool 10 is driven around its drive axis 18, the fingers 19 pivot along a horizontal axis. In order to rake the product located at the front of each tool 10, the fingers 19 are substantially vertical when located in front of the drive axis 18. In order to move the product laterally, the fingers' 19 tips are preferably away from the surface S when the fingers 19 pivot along a horizontal axis. Alternatively, the machine 1 could be a trailed tedder or mower.

In the preferred variant of FIGS. 3 and 4, in order to reduce the width of the machine 1 in the transport configuration, the drive axis 18 of the rear tool 10 is substantially aligned with the drive axis 18 of the front tool 10 in the transport configuration and viewed along the main direction D. In the preferred variant of FIGS. 3 and 4, in the work and maneuvering configuration, the drive axis 18 of the rear tool 10 is offset from the drive axis 18 of the front tool 10, as seen in the main direction D. In this preferred variant, in the work configuration, the product raked by the front tool 10 is raked again by the rear tool 10, forming a common windrow. In the preferred variant, the fingers 19 of the front and rear tools 10 are driven in the same direction of rotation and the fingers 19 located at the front of the tools 10 are driven towards the side of the rear tool 10, as seen in the main direction, thus increasing the working width of the machine 1.

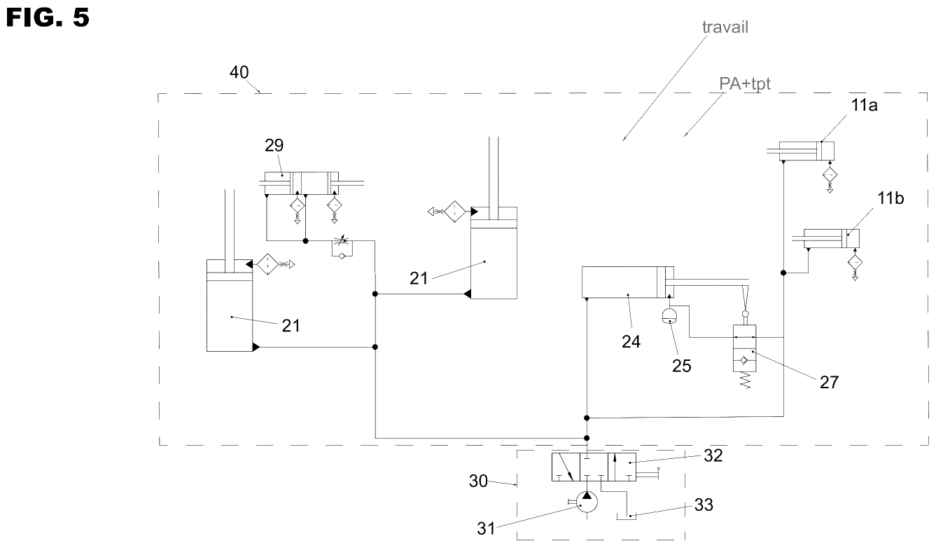

As shown in FIG. 5, the machine 1 contains at least one hydropneumatic accumulator 25. More specifically, the hydraulic circuit 40 of the machine 1 includes at least one accumulator 25. As shown in FIG. 5, in the transport configuration, the hydraulic circuit 40 of the machine 1 is isolated from the hydraulic circuit 30 of the tractor 3.

As shown in FIG. 5, the accumulator 25 is configured to be hydraulically connected to the restoring jacks 11a, 11b in the transport configuration of the machine 1. Preferably, the hydraulic circuit 40 of the machine 1 is such that the accumulator 25 is hydraulically connected to the restoring jacks 11a, 11b in the transport and maneuvering configurations of the machine 1. In this way, each restoring jack 11a, 11b exerts a force on the associated lever 6a, 6b when the respective hitching point 7a, 7b moves vertically relative to the crossing beam 5. In the preferred embodiment, each restoring jack 11a, 11b exerts a force on the associated lever 6a, 6b when the respective hitching point 7a, 7b moves downwards relative to the crossing beam 5. Preferably, in the transport configuration, each restoring device 9a, 9b, respectively each restoring jack 11a, 11b, is configured to exert an upward force on the respective hitching point 7a, 7b when said hitching point 7a, 7b moves downwards relative to the crossing beam 5. Also in the maneuvering configuration, each restoring device 9a, 9b, respectively each restoring jack 11a, 11b, is configured to exert an upward force on the respective hitching point 7a, 7b when said hitching point 7a, 7b moves downwards relative to the crossing beam 5. In this way, the movements of the levers 6a, 6b are blocked, respectively impeded, improving the machine's 1 handling and advantageously preventing it from tipping over, particularly when cornering. It is emphasized that in the transport and maneuvering configurations, the center of gravity of the machine 1 is located higher than in the work configuration, due to the fact that in the work configuration, the or each tool 10 is closer to the surface S, thus making the stability of the machine 1 particularly important in the transport and maneuvering configurations. In addition, the accumulator 25 is configured to maintain the restoring jacks 11a, 11b at their rest length in the transport and maneuvering configurations. Preferably, the accumulator 25 is configured to exert a force keeping the restoring jacks 11a, 11b retracted in the transport configuration and in the maneuvering configuration.

It can be seen on FIG. 4 that a central jack 24 connects the beam 13 on one hand, and one between the drawbar 50 and the rod 51 on another. When the central jack 24 is activated, it makes it possible to raise the beam 13 substantially horizontally. Preferably, the central jack 24 connects the beam 13 and the drawbar 50. Even more preferably, a connecting rod is articulated with the drawbar 50 and the central jack 24.

As can be seen in FIG. 2, in the preferred embodiment, each lever 6a, 6b is pivotally mounted with the crossing beam 5 about a respective transverse axis 17a, 17b. Alternatively or additionally, each lever 6a, 6b could slide relative to the crossing beam 5, in particular along an oblong hole with a vertical component. A sliding connection, however, often induces more wear than a pivot connection and makes kinematics more complex overall. Therefore, in a simple, cost-effective way, each lever 6a, 6b is connected to the crossing beam 5 by a pivot only. Preferably, the vertical movement of each hitching point 7a, 7b is achieved by pivoting about the respective transverse axis 17a, 17b, generating less premature wear. In this way, each restoring jack 11a, 11b exerts a force on the associated lever 6a, 6b when the respective hitching point 7a, 7b pivots downwards relative to the crossing beam 5. In a balanced, simple and cost-effective way, the transverse axes 17a, 17b are preferably coincident.

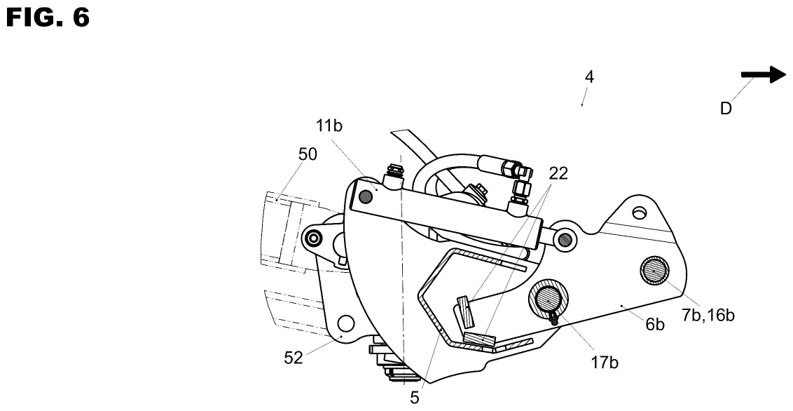

As can be seen in FIG. 6, at least one skid 22 can be fitted between the crossing beam 5 and each lever 6a, 6b. Preferably, two skids 22 are attached to each lever 6a, 6b to dampen potential impacts between the levers 6a, 6b and the crossing beam 5. The skids 22 are preferably made of a flexible material such as rubber or elastomer. Such skids 22 make it possible to improve user or driver comfort. Alternatively or additionally, a flexible skid 22 could be mounted on the inner end of the cylinder of each restoring jack 11a, 11b.

Preferably, the control valve 32 is connected at least to the central jack 24, the lifting jacks 21 and the restoring jacks 11a, 11b, thus reducing the number of hydraulic control valves required to operate the machine 1. In addition, the central jack 24 and each of the lifting jacks 21 are single-acting, reducing the cost price and the complexity of the machine 1. As described previously, in the work configuration of the machine 1, the control valve 32, in a floating position, makes it possible to connect the restoring jacks 11a, 11b to the tank 33. In the work configuration of the machine 1, the control valve 32 is preferably placed in a floating position in which it constantly connects the restoring jacks 11a, 11b to the tank 33, allowing the length of each restoring jack 11a, 11b to adapt to the configuration of the surface S of the ground, reducing stresses in the coupling frame 4 and in the coupling device of the tractor 3 when moving the machine 1 over a bumpy surface S. In the floating position, the control valve 32 therefore connects at least the central jack 24, the lifting jack(s) 21 and the restoring jacks 11a, 11b to the tank 33.

The control valve 32 can also occupy a pass-through configuration, in which it connects at least the restoring jacks 11a, 11b to the pump 31. When the control valve 32 is in the “pass-through” configuration, the central jack 24, the lifting jack(s) 21 and the restoring jacks 11a, 11b are connected to the pump 31, thus moving the tool(s) 10 away from the surface. Respectively, to transpose the machine 1 from its work configuration to its maneuvering configuration, the control valve 32 is placed in the pass-through configuration. In the first variant, the maneuvering configuration corresponds to the transport configuration.

In the transport configuration, the control valve 32 prevents the or each lifting jack 21 from retracting, so that the or each tool 10 is kept further away from the surface S than in the work configuration. Also in the maneuvering configuration, the control valve 32 prevents retraction of the or each lifting jack 21. Preferably, the control valve 32 prevents any oil circulation between the hydraulic circuit 30 of the tractor 3 and the hydraulic circuit 40 of the machine 1.

In the preferred variant shown in FIG. 3, to transpose the machine 1 from its maneuvering configuration to its transport configuration, an additional jack 29 makes it possible to move the rear tool 10 behind the front tool 10, in order to reduce the width of the machine 1. Respectively, the additional jack 29 makes it possible to move the drive axis 18 of the rear tool 10 behind the drive axis 18 of the front tool 10. In this variant, the control valve 32 is connected at the same time to the central jack 24, the lifting jacks 21, the restoring jacks 11a, 11b and the additional jack 29.

Because the weight of the machine 1 allows the central jack 24, the lifting jacks 21 and the restoring jacks 11a, 11b to retract to transpose the machine 1 from its transport or maneuvering configuration to its work configuration, the directional control valve 32 is placed in a floating configuration.

The machine 1 can include a distribution valve 27 which detects when the machine 1 is in the transport configuration. As shown in FIG. 5, the distribution valve 27 detects when the central jack 24 is extended. When the distribution valve 27 detects that the machine 1 is in the transport configuration, the restoring jacks 11a, 11b are connected to the accumulator 25. More specifically, when the distribution valve 27 detects that the machine 1 is in the transport configuration, it connects the restoring jacks 11a, 11b to the accumulator 25. The distribution valve 27 can therefore be a 2-2 control valve with a blocking position in at least one direction and a pass-through configuration. In the work configuration of the machine 1, the distribution valve 27 is in the blocking position. Thanks to this distribution valve, the user avoids the need for additional action, and advantageously cannot forget to connect the restoring jacks 11a, 11b to the tank 33 or the accumulator 25.

In the work configuration, the accumulator 25 is not connected to the restoring jacks 11a, 11b. However, at least during transposition of the machine between its transport or maneuvering configuration and its work configuration, the accumulator 25 is hydraulically connected to at least the central jack 24, preferably in such a way that the central jack 24 exerts a force holding the beam 13 downwards, thus ensuring that the (front) tool 10 reaches its position in the work configuration, respectively that the (front) tool 10 is close to the surface S, thus improving the quality of work of the machine 1. Thanks to this hydraulic construction, the accumulator 25 makes it possible to perform a first function to reach the work configuration and a second function in the transport (and maneuvering) configuration, advantageously reducing the number of accumulators 25 required for the machine 1, and therefore its cost price. Preferably, in the work configuration, the central jack 24, the lifting jacks 21, the restoring jacks 11a, 11b and the additional jack 29 are retracted.

The invention also relates to an agricultural convoy consisting of a tractor 3 and a machine 1.

The invention is not limited to the embodiments and variants described and shown in the figures. Modifications remain possible as regards the composition of the various elements or the substitution by technical equivalents without departing from the scope of protection of the invention.

1. An agricultural machine comprising at least one work tool and a coupling frame by which it is connected to a tractor, the coupling frame comprising a crossing beam and two levers, each carrying a respective hitching point intended to be attached to a respective lower arm of the tractor and which can move vertically relative to the crossing beam, each lever having an associated restoring device which can exert a force on the associated lever when the respective hitching point moves vertically relative to the crossing beam, the machine being able to occupy a work configuration in which the or each tool is close to the surface and at least one transport configuration, in which the or each tool is further away from the surface than in the work configuration, machine wherein each restoring device comprises a hydraulic restoring jack fixed to the respective lever on one side and to the crossing beam on another side, each restoring jack being hydraulically connected to a hydraulic tank in the work configuration.

2. The machine according to claim 1, wherein each restoring jack is a single-acting jack and in that when the tractor and the machine are on a flat surface, the restoring jacks are retracted.

3. The machine according to claim 1, wherein, in the work configuration, the pressure in the chambers of each restoring jack is substantially equal to the atmospheric pressure.

4. The machine according to claim 1, which comprises a hydropneumatic accumulator configured to be hydraulically connected to the restoring jacks in the transport configuration of the machine.

5. The machine according to claim 1, wherein each lever is pivotally mounted with the crossing beam about a respective transverse axis.

6. The machine according to claim 1, wherein, in the transport configuration, each restoring device is configured to exert an upward force on the respective hitching point when said hitching point moves downwards relative to the crossing beam.

7. The machine according to claim 1, wherein two skids are fixed to each lever, in order to dampen potential impacts between the levers and the crossing beam.

8. The machine according to claim 1, wherein it comprises a beam connecting the at least one tool to the coupling frame via a drawbar, a central jack connecting the beam and the drawbar, each tool has an associated lifting jack for raising and lowering the associated tool, and a hydraulic control valve is connected at least to the central jack, the lifting jacks and the restoring jacks.

9. The machine according to claim 6, wherein the central jack and each of the lifting jacks are single-acting.

10. The machine according to claim 3, comprising a hydropneumatic accumulator configured to be hydraulically connected to the restoring jacks in the transport configuration of the machine, and a distribution valve detecting when the machine is in the transport configuration and connecting the accumulator to the restoring jacks when the machine is in the transport configuration.

11. The machine according to claim 3, comprising a hydropneumatic accumulator configured to be hydraulically connected to the restoring jacks in the transport configuration of the machine, wherein, when transposing the machine between its transport configuration and its work configuration, the accumulator is hydraulically connected at least to the central jack, so that the central jack exerts a force holding the beam downwards.

12. The machine according to claim 1, wherein the or each tool is a rotor provided with raking fingers and can be driven in rotation in a direction of rotation, so that the fingers move the product lying on the surface.
